(19) United States
(12) Patent Application Publication
(10) Pub. No.: US 2002/0174040 A1
(43) Pub. Date: Nov. 21, 2002

(54) Method for reconciling data from two different databases in a retail environment

(76) Inventors: Dwayne E. Hurt, Indianapolis, IN (US); Thomas J. Lance, Indianapolis, IN (US); David C. Peck, New Hope, PA (US)

Correspondence Address: E. Victor Indiano, Esq., Indiano, Vaughan & Roberts, Suite 850, One North Pennsylvania Street, Indianapolis, IN, 46204, US

(21) Appl. No.: 10/142,715

(22) Filed: May 10, 2002

Related U.S. Application Data
(60) Provisional application No. 60/291,138, filed on May 15, 2001.

(51) Int. Cl. G06F 17/60

(52) U.S. Cl. 705/28

(57) ABSTRACT

A method is provided for reconciling data between at least a first and a second database containing information about products purchasable in a retail store operation, to determine discrepancies there between. The method includes providing a data processor. The data processor is used for comparing price and product information contained in the first database with product and price information contained in the second database, and for determining whether any discrepancies exist between the product and price information of the first database and the product and price information of the second database. A comparison is report is generated setting forth, in an ordered array, the determined discrepancies between the product and price information of the first database and the product and price information of the second database.

### I. STATEMENT OF PRIORITY

The instant application claims priority to Dwayne E. Hurt, Thomas J. Lance, and David C. Peck, U.S. Provisional Patent Application No. 60/291,138, which was filed on May 15, 2001.

### II TECHNICAL FIELD OF THE INVENTION

The present invention relates to methods for reconciling data from two different databases, and more particularly to a method of reconciling data between two different databases used in a retail environment to ensure that the prices posted on store shelf labels match the prices contained within the store's retail transaction computer systems.

### III BACKGROUND OF THE INVENTION

One constant that exists within a retail environment, such as grocery stores, mass merchandise stores, drug stores, shoe stores, clothing stores, and the like, is that prices of products sold by the store change from time to time. A retailer changes the prices of his goods for a variety of reasons. Probably, the most common reason is that the prices that the retailer pays for the goods change, thereby causing the retailer to adjust the prices that he charges to his customers, to reflect the increases or decreases of the prices she pays for the goods from the manufacturer or wholesaler. Another reason that prices change are specials or sales. When a product goes on “sale,” the price of the item will usually be reduced for a finite period of time (e.g. one week), after which the price is often then restored to its original price.

Before the advent of point-of-sale transaction systems that included bar code scanners, and computerized cash registers, prices were affixed to each individual product unit (e.g. each can of beans, each box of cereal) by stamping a price thereon, or attaching an adhesive backed price label directly on to the product. When the price of the product was changed, it was changed manually on each individual product unit. For example, in grocery stores, prices were stamped on canned goods with an ink solution applied by a changeable rubber stamp like device known as a Garvey® stamper.

In a grocery store environment, the price change procedure was usually performed by the store's stock crew who would be given a list of prices to be changed. The stock crew then used the price change list to manually change prices on each of the individual product units. To change the prices of canned goods, a suitable solvent such as laquer-containing hair spray was sprayed on the lids of the cans containing the stamped prices; and a paper towel or rag was used to wipe off the lids, thereby obliterating the old price thereon. The can lids were then re-stamped with the Garvey® stamper to apply the new price.

Most high-volume retail merchants no longer apply prices to each individual item, because to do so is extremely labor intensive, and hence expensive. Today, only a few items in a typical grocery store have price labels applied thereto. Rather, a shelf tag or shelf label, that usually consists of a printed label having an adhesive backing, is placed on the shelf end lip adjacent to the item to which it pertains. The shelf label contains the price of the product, and is placed on the end of the shelf in a position where the consumer can easily view the price of the product before deciding whether to buy it. The only “price marking” contained on the particular product is a product-identifying “UPC®” bar code. The UPC® bar code serves only to identify the particular product, and rarely gives any price information that is useable or readable by the consumer.

The otherwise price-unmarked product is then brought to the register where its Universal Price Code (UPC®) bar code is read by the scanner portion of the computerized register scanner. The scanner reads the bar code to determine which product is being scanned, and then retrieves the price information for that particular product from the store's central computer (or the register's internal memory) that is in electronic communication with the cash register. The price of the item is then displayed on a display, such as an LCD or 7-element display screen for the consumer to view as the item is being “rung up”. This price is then added to the price of other products purchased by the consumer to arrive at the consumer's total bill.

One drawback with this system is that the shelf price may not match the price contained within the retailer's computer, thus leading to a disparity between the price the consumer believes she is paying, and the price that she is actually charged.

This did not occur with individually priced items. Since individually priced items bore the price on a particular unit, the consumer could view the price on the product at the checkout lane, and did not have to remember the price that was displayed on the shelf label, if such existed. Before computerized scanning cash registers, the cashier would read the price off the top of the product, and input this price manually into the cash register. The cashier-inputted price would then be added to the prices of the other items purchased by the consumer to arrive at the consumer's total charge.

Notwithstanding the fact that the price was printed on the individual item, problems and discrepancies still occurred with the manual system, since items were sometimes mis-marked, and busy cashiers from time to time input erroneous prices into the register. All in all, the computerized scanning register has generally resulted in the consumer being charged more accurately than occurred with the manual, non-computerized cash register, and individually marked items.

Notwithstanding a reduction of errors that has been brought about by the computerization of the transaction process in the retail environment, errors still occur. One source of errors springs from the very large number of individual items that are typically carried by a modem supermarket. For example, modem grocery stores may consist of 40,000 to 80,000 square feet of selling space, and carry tens of thousands of individual items. Combination stores, such as those found at Super Wal-Mart®, SuperTarget® and Meijers® are even larger, as such stores usually include both a full-size grocery store, and a full-size general merchandise store within one building, both of which are serviced by one networked computer system containing a plurality of registers. The sheer volume of items in such a store makes it likely that there will never be a time when the price data within the store's computers matches perfectly with the data contained on all of the shelf labels.

Another source of error potential resides from the fact that the database of information that is fed to the store's cash register computer system may be different than the database used to generate the store labels. As such, discrepancies between the two databases can lead to a situation where the shelf label price differs from the price contained within the cash register computer system. A discrepancy of this type can result in the price that the consumer is charged for the product differing from the price shown on the shelf label.

An additional source of errors has its origins in timing, as the prices contained within the store's cash register may be changed at a time different than a time at which the store shelf price labels are applied to the shelves. Since the application of new shelf labels is a time-consuming manual process, that is not susceptible to instantaneous automation, it is likely that a certain period of time will exist during which new labels are being applied, when the shelf labels do not always reflect the then-current prices contained within the cash register computer system.

Therefore, one object of the present invention is to provide a system for reconciling discrepancies between prices contained within a retail store's cash register computer, and prices contained on the shelf labels.

It is another object of the present invention to help reduce time induced discrepancies by providing a method of preparing shelf labels that facilitates their timely and expeditious placement upon the shelves of retail operations. Such an expeditious placement can also help to reduce the labor costs of affixing the shelf labels to the shelves.

### IV SUMMARY OF THE INVENTION

In accordance with the present invention, a method is provided for reconciling data between at least a first and a second database containing information about products purchasable in a retail store operation, to determine discrepancies therebetween. The method comprises providing a data processor. The data processor is used for comparing price and product information contained in the first database with product and price information contained in the second database and for determining whether any discrepancies exist between the product and price information of the first database and the product and price information of the second database. A comparison is report is generated setting forth, in an ordered array, the determined discrepancies between the product and price information of the first database and the product and price information of the second database.

In one preferred embodiment, the report generator is programmed to generate reports in a variety of formats to enable the retail operation to correct discrepancies either by changing information in the cash register transaction database, or alternately by changing the information contained on the shelf labels to ensure that the shelf label data matches the data within the cash register database.

In another preferred embodiment, the first database includes price and product information used by point of purchase terminals at the retail store operation and the second database includes information useable for producing pricing labels affixable to at least one of products to be sold and on shelves for holding the products to be sold. Additionally, the comparison report contains labels so produced, wherein the discrepancies are corrected, for use within the retail store operation for which discrepancies existed. These corrected labels are designed for placement on the at least one of the products to be sold and the shelves for holding the products to be sold.

### V FEATURES AND ADVANTAGES OF THE PRESENT INVENTION

One feature of the present invention is that it reconciles data between first and second databases, and uncovers discrepancies between the two databases. This feature has the advantage of reducing discrepancies between posted prices and prices charged by the cash register transaction system at checkout to thereby reduce errors. As price discrepancy errors can result in customer dissatisfaction, the reduction of such errors will help reduce customer dissatisfaction. Reducing errors promotes customer happiness, and hopefully, customer loyalty to the establishment. Additionally, reducing the number of errors helps to promote customer confidence in the system which, of course, is an element of customer satisfaction.

Another feature of the present invention is its ability to provide discrepancy reports. These discrepancy reports comprise listings of those items wherein discrepancies exist between the shelf label price or description and the cash register transaction system price or product description. These reports can be provided in a variety of formats, and with a variety of sorting options. These various sorting options and formats provide additional utility by providing the potential for making it easier for store personnel to reconcile discrepancies.

One sorting option is to sort the discrepancy list by product identifiers such as SKU or UPC® numbers. For example, a small-sized box of Kellogg's® Corn Flakes has a different UPC number, and is a different SKU than a large-sized box of Kellogg's® Corn Flakes.

A report sorted according to SKU or UPC® numbers would use the SKU or UPC® number as a basis for determing the order in which the products were arranged or listed on the report. A second option involves sorting discrepancies by product name, in an alphabetical list. A third option involves the discrepancy being sorted by retail department; and a fourth sorting option is to sort the discrepancy items by their physical (geographic) position within the store. In this fourth option, for example, all of those discrepancy items would be grouped together that were placed within a particular aisle of the store.

In addition to the sorting options, another feature of the present invention is that the processing and reconciling system of the present invention can be configured to produce discrepancy reports either in paper format for use by store personnel, or in an electronic format. The direct placement of this discrepancy report in a paper format can be highly useful when the store does not have an Internet or other data connection, or otherwise does not have equipment that is capable of receiving electronic information and converting it into a paper format. Applicants also believe that a paper format is likely to be very useful by the store personnel working on the store floor changing shelf labels. Further, a paper format is necessary for printing shelf labels.

Alternately, the present invention can place the data in an electronic format for direct electronic transmission to the store. When received by the store in an electronic format, the data can be used to make reconciliations of the discrepancies electronically, along with the electronic information being useable to create a printed report if the store has an appropriate printer. Further, the electronic data received by the store can be downloaded into a hand-held portable electronic device (similar in concept to a PDA) that can be carried by store personnel to various locations within the store.

The discrepancy report data can also be transmitted to a reconciling processor, where, through the addition of either a human or an artificial intelligence input, the discrepancies can be displayed, or printed out; and necessary corrections can be made to the discrepancy list to terminate the discrepancies. The corrected data can then be transmitted to the cash register system database, and to the shelf label database so that the discrepancies that formerly existed between the two are eliminated, through the reconciling of data provided by the invention.

These and other features of the present invention will be apparent to those skilled in the art, upon review of the detailed description of the perceived best mode of practicing the invention in the accompanying drawings, wherein:

### VI BRIEF DESCRIPTION OF THE DRAWINGS

FIG. 1 is a flow chart illustrating the method of the present invention;

FIG. 2 is a flow chart showing the various elements of an exemplary discrepancy report;

FIG. 3 is a flow chart showing the various sub-categories of a primary category of items found in an exemplary discrepancy report;

FIG. 4 is a flow chart showing the various sub-categories of a primary category of items found in an exemplary discrepancy report;

FIG. 5 is a flow chart showing the various sub-categories of a primary category of items found in an exemplary discrepancy report;

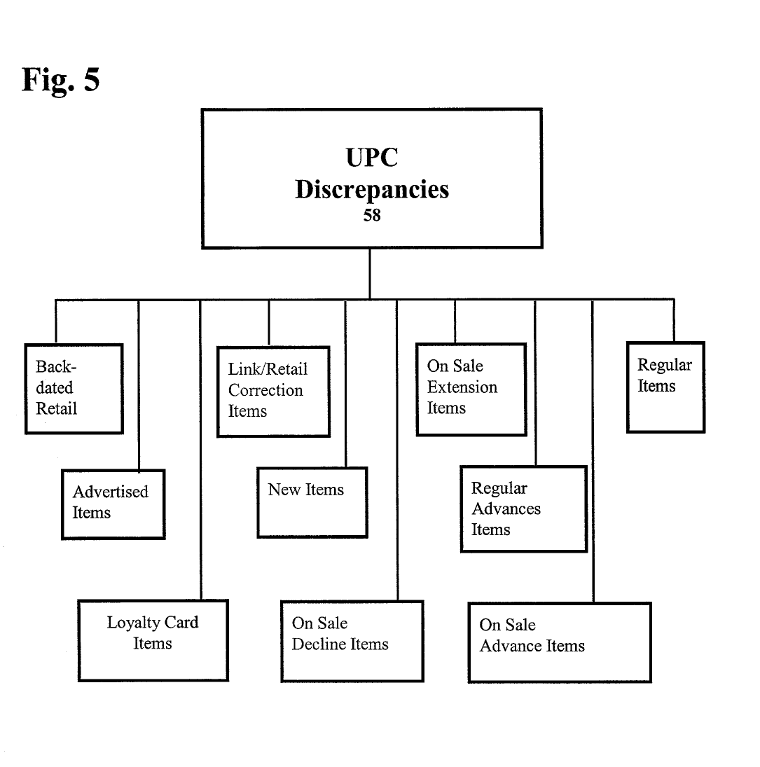

FIG. 6 is a flow chart showing the various sub-categories of a primary category of items found in an exemplary discrepancy report;

FIG. 7 is a flow chart showing the various sub-categories of a primary category of items found in an exemplary discrepancy report;

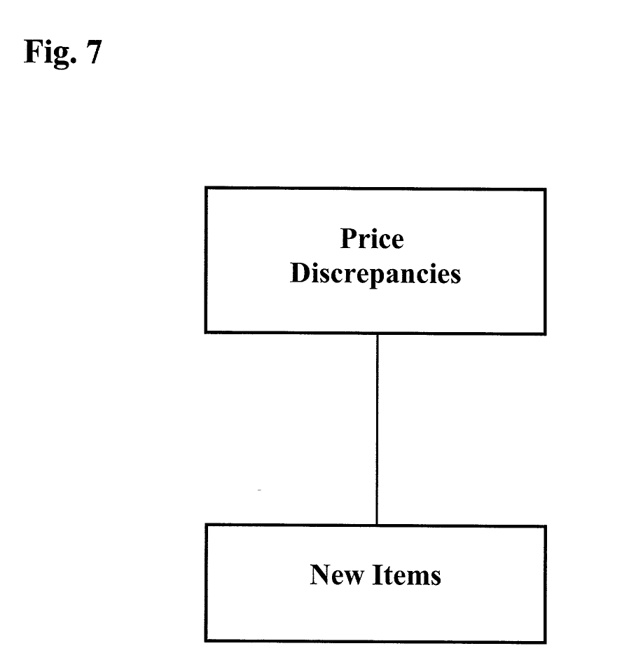

FIG. 8 is a flow chart showing the various sub-categories of a primary category of items found in an exemplary discrepancy report; and

FIG. 9 is a flow chart showing a single sub-category of items found in an exemplary discrepancy report.

### VII DETAILED DESCRIPTION OF PREFERRED EMBODIMENTS

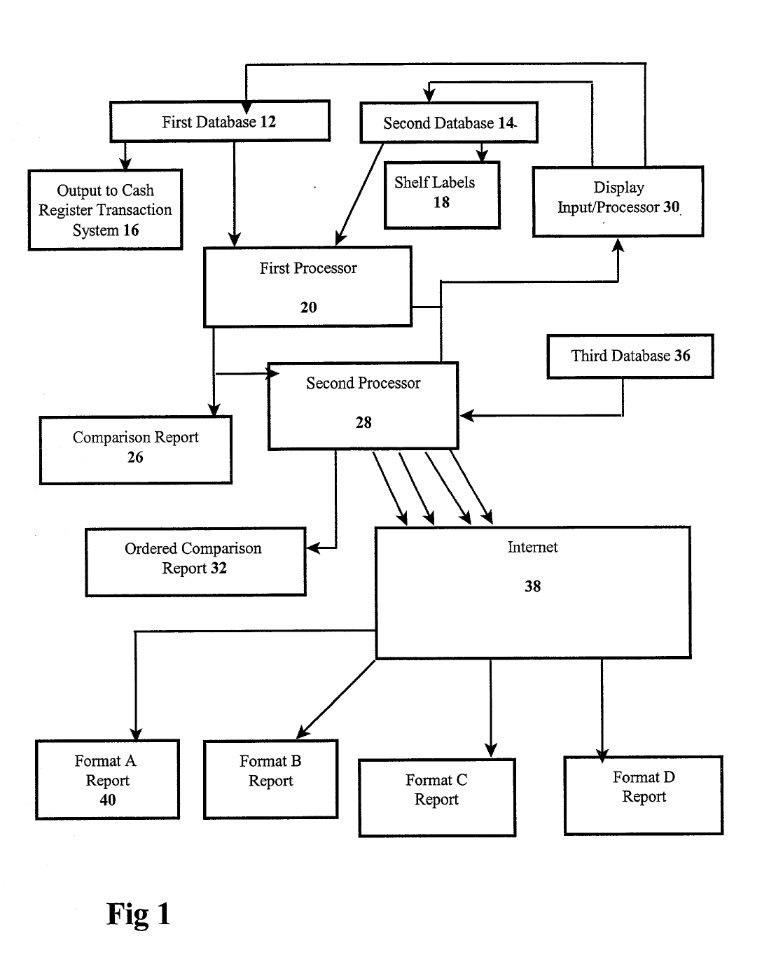

The various components and data flow paths for the data reconciliation system 10 of the present invention are best shown in FIG. 1. The data reconciliation system 10 begins with a first database 12 and a second database 14. Usually, the first database 12 comprises a database containing a listing information about all of the various items (SKUs) that are usually contained within the inventory of the store in which the data reconciliation system 10 is being used. In most cases, the first database 12 contains the SKUs for every store within the chain of grocery stores, mass merchandise stores, tobacco stores, liquor stores, drug stores, etc., with which the data reconciliation system 10 is being used.

The second database 14 contains a similar database of items sold by the store or store chain. The primary difference between the first database 12 and the second database 14 is that the output from the first database 12 is delivered via a communication means, such as a modem, wireless connection, network, etc. to a cash register transaction system 16 of a particular store, or group of stores of a chain. As such, since the chain headquarters or computer facility may be remote from the particular store in which the information is being used, the communication between the first database 12 and the cash register transaction system 16 may be a remote link, provided by telephone line, satellite feed, etc. Alternately, the output for the cash register system 16 can be a printout that is later input into the electronic cash register system at the particular store.

The information contained within the cash register transaction system 16 is information that is used to process the customer's checkout. For example, at the cash register station of the store, the items to be purchased are scanned so that the product's bar code can be read by the cash register scanner, which then transmits the bar code information to the store's central processing unit, wherein the bar code is recognized as a particular unit (SKU). The SKU information and price are then transmitted back to the remote cash register being operated by the cashier. The cash register adds the item, and its price, to the other items and prices being purchased by the consumer, to help achieve the total bill owed by the consumer for the goods being purchased. Concurrently, information regarding the sale of the particular unit(s) of the particular item may be transmitted to an inventory-related database, which may either be separate from database 12, or a part of database 12. The inventory database is utilized to enable the store to keep track of the number of items sold, the type of item sold, and by deductive logic, the items of a particular type remaining in the store's inventory.

As discussed above, the data contained within the first database 12 often differs in some respect from the data contained in the second database 14. Any differences between the two databases 12, 14 will cause discrepancies to occur between the information contained on a shelf label (that usually includes item description, UPC number, and other information about the product to which it pertains) and the information contained in the cash register transaction system 16.

A first processor 20 is provided for processing the data contained in the first database 12 and the data contained in the second database 14, to compare the two sets of data, to provide a comparison report 26, wherein any discrepancy between the data contained in the first database 12 and the data contained in the second database 14 are listed, so that such discrepancy can be dealt with appropriately by store personnel to ensure that the price and item descriptions contained on a shelf label 18 match the price and item descriptions contained within the cash register transaction system 16, and hence, on the register tape receipt given to the customer.

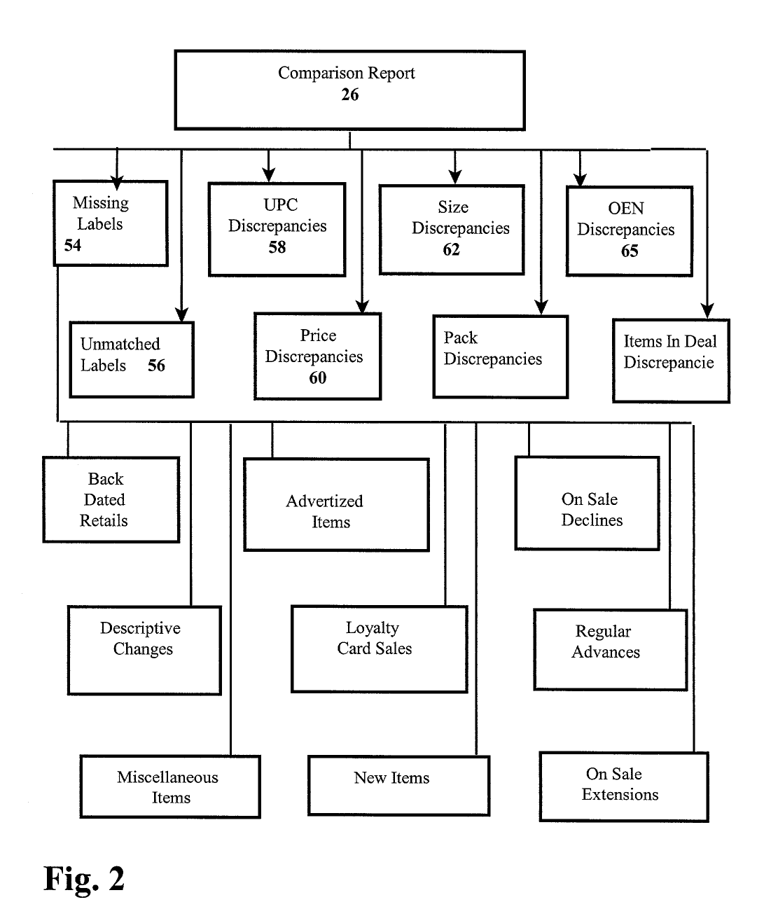

The comparison report 26 that is generated from the comparison of the first database 12 and the second database 14 will be described below in more detail in connection with FIG. 2.

In addition to the first processor 20, a second processor 28 can also be employed in a preferred embodiment of the invention. Although the second processor 28 is shown as a processor separate from the first processor 20, the first and second processors 20, 28 can comprise the same CPU, or alternately, parallel processors contained within the same central processing unit. The output of the first processor 20 is preferably input into the second processor 28, along with data from a third database 30.

The third database 30 contains information that is useful for ordering the information prepared on the comparison report, to produce an ordered comparison report 32. The ordered data contained within the third database 30 can include information such as department data for their various items contained within the first and second databases 12, 14 so that the items provided on the ordered comparison report 32, are ordered by some pre-selected criteria. This pre-selected criteria can include things such as the placement of the items in an ordered array by department, by geographic position within the store, and/or by a particular item category, such as on sale items, loyalty card items and the like.

The information from the second processor 28, or alternately, from the first processor 20 can be input into a display/input processor 36. The display/input processor 36 is designed to display the discrepancies uncovered by the data reconciliation comparison performed by the first and/or second processor 20, 28 to give a computer-operator the opportunity to reconcile the discrepancies. For example, the display portion of display/input processor may display that a particular item, such as a 16 oz. can of Del Monte® Green Beans is shown on the shelf labels as being priced as $0.97, but is shown on the cash register transaction system output as being priced at $0.99. The user operating the input processor portion of display/input processor 36 can then reconcile the information, such as by changing one or both prices, to ensure that both are correct, and so that the information on the shelf labels 18 agrees with the information that is being sent to the cash register transaction system 16. This now reconciled information can then be transferred back to the first 12 and second 14 databases, thereby eliminating the particular discrepancy between the first 12 and second 14 databases.

As stated above, the output from the second processor 28 comprises a comparison report 32, containing an ordered array of data. The report can be either a paper or an electronic report. For example, the output from the second processor 28 can be transmitted over a global computer network, i.e. the Internet 38, to a remote location, such as the particular store for which the data reconciliation is being made. As suggested by the four arrows leading from the second processor 28, the data can be presented and placed on the Internet 38 in a variety of formats. One or all of these formats can then be downloaded from the Internet 38 into different format reports such as the format A report 40, format B report 42, format C report 46, and format D report 48. Preferably, the particular natures of the various formatted reports 40, 42, 44 and 48 should be chosen to present the discrepancy data in a way that will be most useful to the user of the report, which users usually comprise store management and stock personnel.

For example, the format A report can be a “geographically” based report, wherein the items on the report 40 are ordered according to their geographic position within the store. Depending upon the sophistication of the system, and the sophistication of a knowledge base of item placement within the store, the items within format A can be ordered so that all of the items that are contained within, for example, aisle one of the store can be grouped together on the report.

If the system is even more sophisticated, the items within the report for a particular aisle can be placed in an ordered array on the report representative of the geographic order in which they are found within the particular aisle. For example, the items can be placed in a north to south array corresponding to the geographically north to south array of items found on the east side of aisle 1 and then in a south to north array for those items geographically positioned on the west side of aisle 1. Through this arrangement, especially with the shelf label report, the stock personnel can apply the shelf labels in the appropriate places on the shelves by walking south along the east side of aisle 1, and then walking north on the west side of aisle 1, until all of the shelf labels in aisle 1 are properly placed. By so ordering the shelf labels, all the shelf labels should be positioned so that the spacial separation between the goods adjacent to each other on the shelf label report are minimized. This particular ordering arrangement can reduce labor costs and the time required for affixing the shelf labels to the shelves by eliminating the need for the stock person to spend time traveling between aisles.

In another example, the report 42 of format B can be a departmental report, wherein the items are segregated by department. This particular type of ordering would be useful for dividing work up among stock crew personnel, since different departments are usually handled by different personnel within a store. In the report 40 of format B, for example, all of the shelf labels that pertain to the frozen food items are placed together, for tendering to the frozen food manager; all of the items in the dairy department would be segregated for tendering to the dairy manager; and all of the dry good items would be placed together for tendering to the dry goods stock manager.

A third alternate embodiment report format 46, designated herein as report format C, 46, may comprise a format wherein the products contained on the report 46 output are ordered according to status criteria, such as all on-sale items being grouped together, all the “loyalty card” items being grouped together, etc.

The fourth report 48 format, shown as report format D 48, can be a fourth ordering system, wherein the goods are ordered by the cause of the discrepancy, such as all of the items with incorrect UPC® numbers being placed in one group, all items that are new to the store being placed in a separate group, and so forth.

Regardless of the format, the format reports 30, 42, 46 and 48 are used by store personnel to correct discrepancies, either on the shelf labels 18, or in the cash register transaction system 16. In the case of shelf label discrepancies, the discrepancies are handled by a corrected shelf label being placed on a shelf (or other merchandise holding device) adjacent to the item to which it pertains. In the case of cash register transaction system discrepancies, the discrepancies are handled by corrected information being input into the cash register transaction system 16, so that the discrepancies no longer exist.

Turning now to FIG. 2, one exemplary comparison report 26 and its components will be described in detail.

The comparison report 26 is divided into a plurality of main categories. These categories include SKU's that contain missing labels; those SKU's that contain unmatched labels; and those SKU's having UPC discrepancies. UPC discrepancies are discrepancies in the Universal Price Code contained in one of the two databases 12, 14. Another category are price discrepancies, wherein the price data for the item that is on the shelf label database 14 differs from that which is contained in the computer transaction database 12. The size discrepancy category comprises those items wherein the size listed for the product (e.g. 16 oz. can of green beans being mistakenly listed as 29 oz. can of green beans) is listed incorrectly in one or both of the databases 12, 14.

The pack discrepancy category of items relates to those items wherein the number of items contained within a particular product (such as 6 PopTarts® within a PopTarts® 6-pack) is incorrect in one of the two databases 12, 14. Another category is OEN discrepancies. OEN discrepancies are discrepancies wherein the seven digit Order Entry Number maintained for a particular product is incorrect in one of the two databases 12, 14. The final category in the exemplary comparison report 26 is a category labeled as “Items in Deal Discrepancies”, that relate to discrepancies that are contained in particular items that refer to those items wherein the number of items in the offer (such as the “2” in 2 for $1.00) is incorrect in one of the two databases 12, 14.

Although the particular categories of the comparison report 26 shown in FIG. 2 are not exclusive, they do represent one way of ordering the data within the comparison report 26.

Each of the major categories, e.g. missing labels, UPC discrepancies, etc., also may contain one or more sub-categories. For example, the missing labels category 54 includes nine sub-categories, including back-dated retail items, that comprise items that refer to previous price changes; “descriptive changes” that comprise those goods whose description needs to be changed; “miscellaneous items” that are items not properly classifiable at any place; and “advertised items”. Other categories of items include “loyalty card sales”, that comprise those items that are placed on sale for those users of a particular chain's loyalty card, such as the Kroger® Plus, or a Marsh® Fresh Idea Card®. Further categories include “new items”; “on-sale declines” that are products whose price is decreasing, for which a discrepancy exits; and “regular advances” that comprise products that are undergoing normal price changes advanced by the manufacturer, for which a discrepancy exists.

The final sub-category of the “missing labels” items shown in FIG. 2 are “on-sale extensions” comprises those items that were previously on sale, and for which the sale price is being extended into another marketing period.

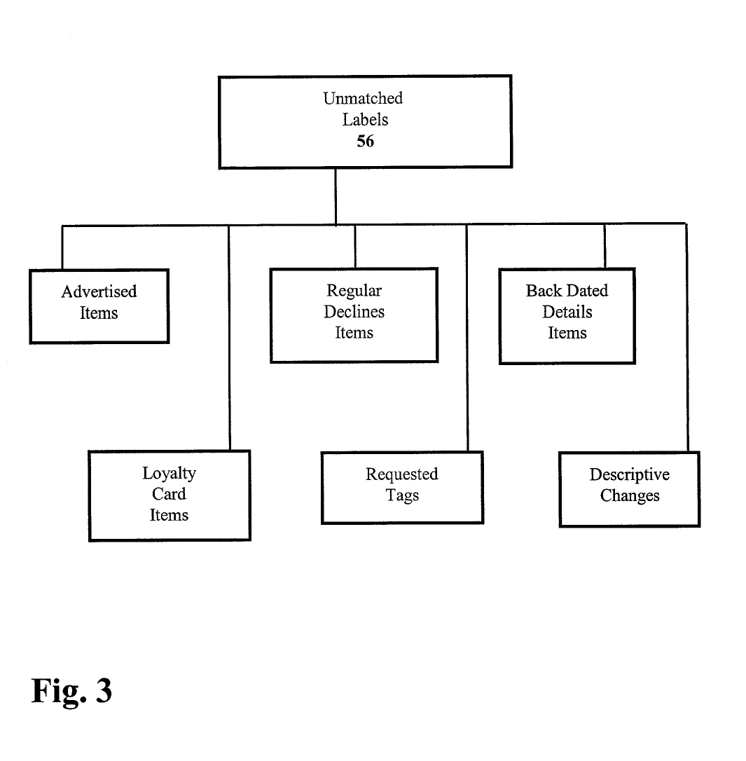

Turning now to FIG. 3, the various sub-categories under the “unmatched labels” category 57 are shown. It will be noticed that many of the categories are similar to those shown in FIG. 2. However, some categories are missing, which generally denotes the fact that no items exist that both: (1) have discrepancies; and (2) fit within the missing labels category. Additional categories may be present, if “unmatched label” discrepancies exist for any products that do not fit within one of the previously described sub-categories. The sub-categories shown in FIG. 3 include “advertised items,” “regular decline items,” “back-dated detail items,” “loyalty card items,” “requested tag” and “descriptive changes items.” The “requested tag” sub-category relates to those items for which tags have been requested, such as those items wherein the previous shelf label has become torn, worn, or otherwise obliterated.

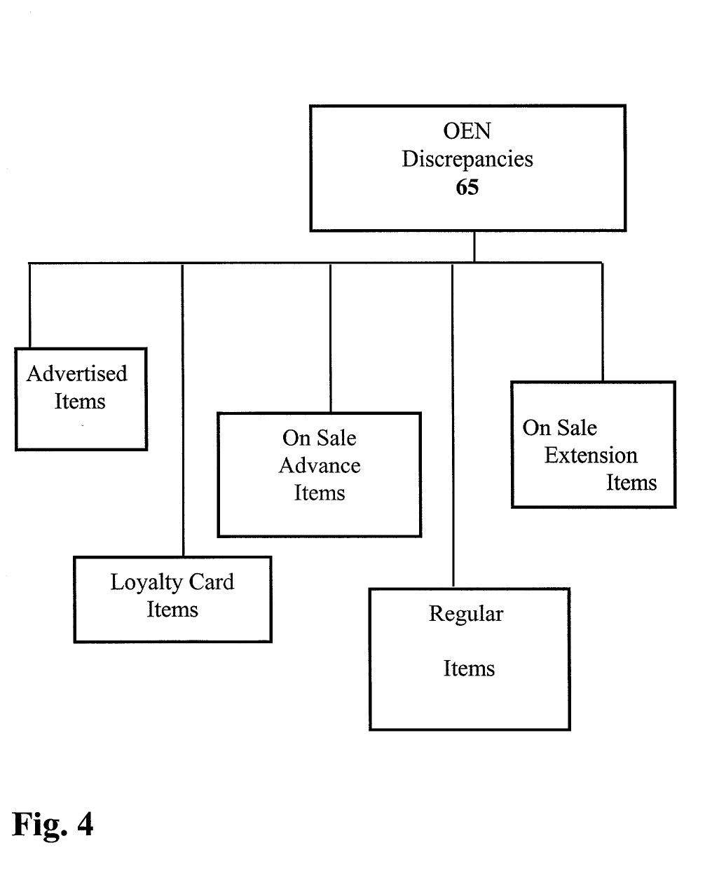

FIG. 4 shows the various sub-categories under the OEN discrepancies main category 65. It will be noticed that only five sub-categories exist under OEN discrepancies 65, suggesting once again that no items exist that are contained in one or more of the sub-categories of FIG. 3 that have any OEN discrepancies. The sub-categories under the OEN discrepancies category include “advertised items,” “sale advance items,” “on-sale extension items,” “loyalty card items,” and “regular items”.

The particular main category having the most sub-categories is the UPC discrepancies main category 58. As alluded to above, UPC discrepancies 58 relate to items wherein the Universal Price Code number that is contained within the shelf label database has some discrepancy with either the UPC number contained within the cash register transaction database 16, or alternately, some discrepancy between the actual UPC numbers and those numbers contained on a database.

The UPC discrepancy sub-categories include “back-dated retail items” that comprise items that refer to previous price changes, “advertised items,” “loyalty card items,” and “link/retail correction items.” “Link/retail correction items comprise those items that refer to temporary link numbers assigned to the regular base price of a product for a specific sale period.

Other sub-categories include “new items”, “sale decline items” that comprise new, store-specific, commodities and items marked for post sale regular pricing; “on sale extension items”; and “regular advances items.” Regular advance items comprise items that are marked for sale extension periods and items marked as having a price change by the manufacturer.

The final two categories include “on-sale advance items,” that comprise those items that are marked as price decreases by the manufacturer and “regular items.”

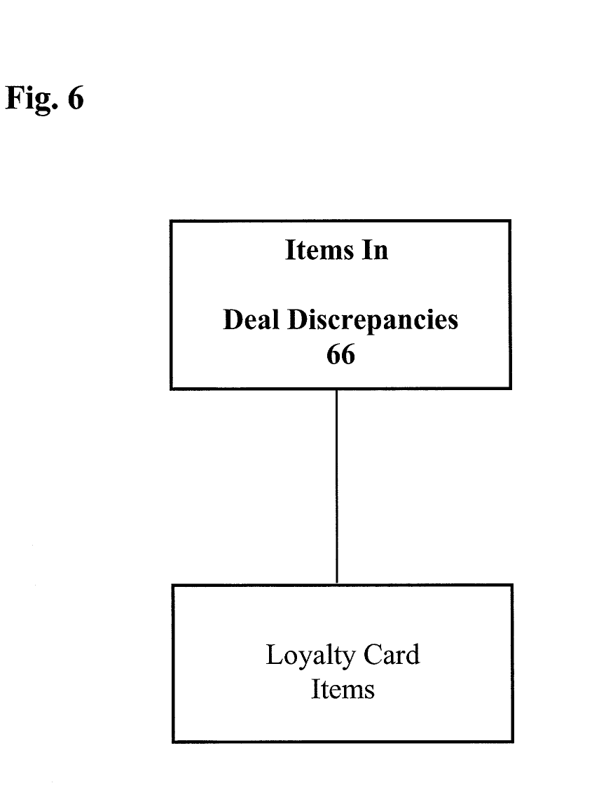

Turning now to FIG. 6, it will be noticed that the “items in the deal discrepancies” category has only one sub-category. Similarly, the price discrepancy category 60 also includes one sub-category, that is “new items.” Because the type, nature, and amount of discrepancies are likely to change from marketing period to marketing period (usually week to week), a possibility exists that although the price discrepancy category 60 only includes one sub-category for the particular week shown, it may contain a plurality of sub-categories in the subsequent or previous week.

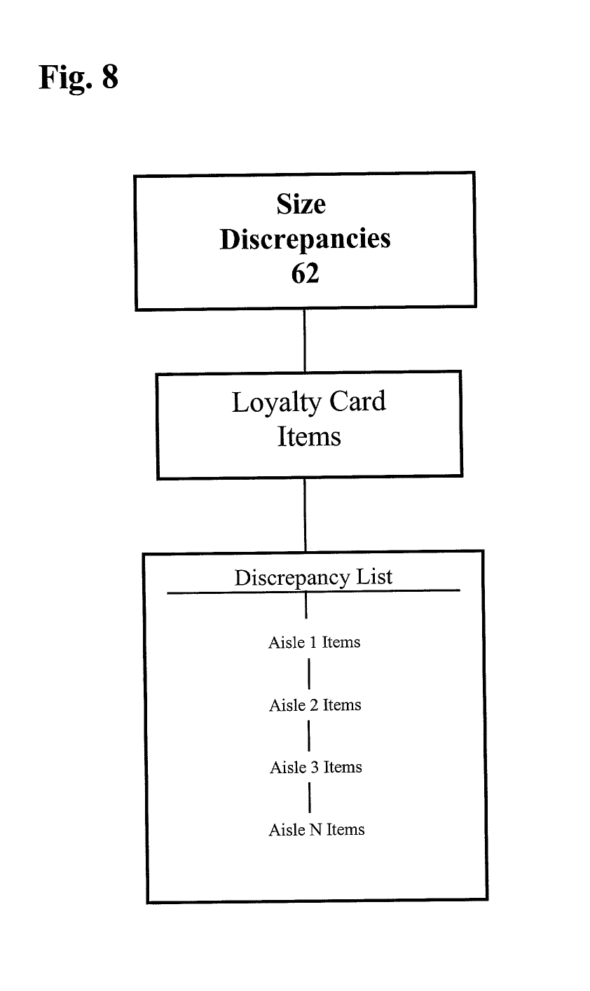

FIG. 8 shows that the size discrepancy main category 62 contains only a single subcategory, “loyalty card items.” Shown under the “loyalty card items” is a block 80 that schematically illustrates the manner in which the various items in the “loyalty card” sub-category are ordered on the discrepancy report portion for that sub-category. In the report 80 shown in FIG. 8, the discrepancy list comprises an array of items that are ordered geographically so that all of “aisle 1” items are together, followed by all of “aisle 2” items, then the “aisle 3” items and so forth, until the last aisle (aisle N) are displayed at the end of the list.

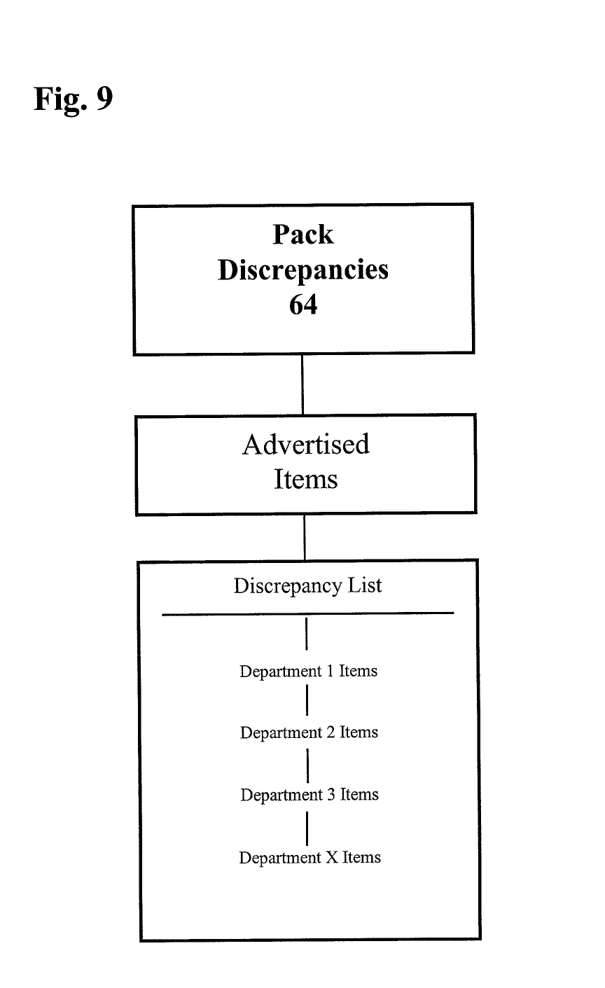

FIG. 9 schematically illustrates that the pack discrepancy category 64 only includes a single sub-category comprised of “advertised items.” The discrepancy list report 84 shown in connection therewith comprises an ordered array of items having discrepancies. However, unlike discrepancy list 80 (FIG. 8) in discrepancy list 84 shown in FIG. 9, the items are ordered by department. In this ordered array, the items of “department 1” (e.g. frozen foods) will be grouped together, followed by the items of “department 2” (e.g. dairy products), then the items of “department 3” (e.g. paper products), and so forth, until the last department (shown here as department X) items are displayed at the end of the list.

Although the invention has been described with reference to the currently perceived best mode of practicing the invention, it will be appreciated by those skilled in the art the variation and modifications exist which are encompassed within the spirit of the invention.

What is claimed:

1. A method for reconciling data between at least a first and a second database containing information about products purchasable in a retail store operation, to determine discrepancies therebetween, the method comprising:
providing a data processor
using the data processor for comparing price and product information contained in the first database with product and price information contained in the second database and for determining whether any discrepancies exist between the product and price information of the first database and the product and price information of the second database, and
generating a comparison report setting forth in an ordered array, the determined discrepancies between the product and price information of the first database and the product and price information of the second database.

2. The method of claim 1 wherein the step of generating a comparison report comprises the step of generating a comparison report wherein the discrepancies are placed in an ordered array sorted alphabetically by product name.

3. The method of claim 1 wherein the step of generating a comparison report comprises the step of generating a comparison report wherein the discrepancies are placed in an ordered array sorted by a product identification number.

4. The method of claim 3 wherein the product identification number is selected from a group consisting of SKU identifiers, product stock number identifiers and universal price code identifiers.

5. The method of claim 1 further comprising the steps of
using the comparison report to reconcile discrepancies listed thereon, and
transmitting the reconciled information back to the first and second databases so that the price and product information contained in the first database matches the price and product information contained in the second database.

6. The method of claim 1 wherein the first database includes price and product information used by a point of purchase terminal at the retail store operation and the second database includes information useable for producing pricing labels for affixing to at least one of products to be sold and on shelves for holding the products to be sold, wherein the step of generating a comparison report comprises the step of generating a report setting forth those pricing labels within the retail store operation for which discrepancies existed.

7. The method of claim 6 wherein the step of generating a report setting forth those pricing labels includes the step of generating a report containing corrected pricing labels for placement on the at least one of the products to be sold and the shelves for holding the products to be sold.

8. The method of claim 1 wherein at least one of the first and second databases includes information about the retail store operation department in which products are placed, wherein the step of generating a comparison report includes the step of generating a comparison report wherein the discrepancies are sorted by department.

9. The method of claim 8 further comprising the steps of using the comparison report to reconcile discrepancies thereon, and
generating a second comparison report including reconciled discrepancies sorted by department of the retail store operation.

10. The method of claim 1 further comprising a third database including information about the retail store operation department in which products are placed, wherein the step of generating a comparison report includes the step of generating a comparison report wherein the discrepancies are sorted by department, reconciling the discrepancies, and generating a comparison report wherein the reconciled discrepancies are sorted by department.

11. The method of claim 1 further comprising a third database including information about the retail store operation, said information including at least one of information about the retail store department in which products are placed and information about the location within the retail store operation at which products are placed.

12. The method of claim 1 wherein at least one of the first and second databases includes information about the location within the retail store operation at which products are placed, wherein the step of generating a comparison report includes the step of generating a comparison report wherein discrepancies are sorted by geographic location.

13. The method of claim 12 further comprising the steps of reconciling discrepancies between the first and second database found on the comparison report, and generating a second comparison report including reconciled discrepancies sorted by geographic location within the retail store operation.

14. The method of claim 13 wherein the step of generating a second comparison report includes the step of generating a second comparison report as a set of price labels affixable to at least one of products to be sold and to shelves for holding products to be sold.

15. The method of claim 14 wherein the price labels are sorted as to location within the retail store operation so that adjacently-positioned labels on the second comparison report correlate with generally adjacently-positioned products within the retail store operation.

16. The method of claim 1 wherein the step of generating a comparison report, setting forth in an ordered array, the determined discrepancies include the step of setting forth the determined discrepancies in at least two category groupings.

17. The method of claim 16 wherein the at least two category groupings are selected from the group consisting of missing label discrepancies, size discrepancies, OEN discrepancies, unmatched labels discrepancies, pack discrepancies and items in pack discrepancies.

18. The method of claim 17 wherein the step of setting forth the discrepancies in at least two category groupings includes the step of establishing at least two sub-category groupings under at least one of the category groupings, and setting forth at least a portion of the discrepancies in the at least two sub-category groupings.

19. The method of claim 18 wherein the at least two sub-category groupings are selected from the group consisting of back dated retails, advertised items, on sale declines, descriptive changes, loyalty card sale items, regular price advance items, new items, on sale extension items, and miscellaneous items.

20. The method of claim 16, wherein the at least two category groupings are selected from the group consisting of back dated retails, advertized items, on sale declines, descriptive changes, loyalty card sale items, regular price advance items, new items, on sale extension items and miscellaneous items.
